(19) United States
(12) Patent Application Publication
(10) Pub. No.: US 2009/0114485 A1
(43) Pub. Date: May 7, 2009

(54) Lift truck fork aligning system with operator indicators

(76) Inventor: Richard T. Eggert, Easton, PA (US)

Correspondence Address: SANFORD J. PILTCH, ESQ., 1132 HAMILTON STREET, SUITE 201, ALLENTOWN, PA, 18101, US

(21) Appl. No.: 11/982,281

(22) Filed: Nov. 1, 2007

(51) Int. Cl. B66B 3/02; B66F 9/06

(52) U.S. Cl. 187/394

(57) ABSTRACT

A sensor system for substantially simultaneously measuring and detecting the verticality or perpendicularity of the forklift vehicle mast and the vertical height displacement of the forks. The sensor system then alerting the operator of the satisfactory assessment of the precondition alignment of the forks so that, without the need for visual checking of the vertical positioning of the forks, the operator can insert the forks under the pallet load support surface and lift the load without causing damage to either the pallet or the load.

### BACKGROUND OF THE INVENTION

The invention resides in the field of leveling and alignment sensors and indicators for material handling vehicles. The present invention relates to a system for aligning and determining lift truck fork levelness with and distance from the underlying surface. The system of the present invention uses sensors to monitor and determine the lift truck fork alignment by measuring verticality and support surface proximity, and then affords the operator indications of these measurements in order to avoid damage to material on a pallet, or to the pallet itself.

Lift trucks commonly have forks used to engage and lift material to be moved from one location to another location. The lift trucks usually have a manually operated valve to control the vertical movement of the forks by an operator. The operator of the lift truck adjusts the elevation of the forks in order to engage the pallet supporting the material. The material is frequently positioned on a pallet for convenient movement and storage. Proper alignment of the forks within the pallet opening below the load support surface is necessary to engage the load in a safe and secure manner. The operator can sometimes misjudge the elevation of the forks and improperly engage the material with the tips of the forks, i.e., spearing, causing damage. The result may be damage to, or tipping of the material from the pallet, or movement of the pallet relative to the lift truck preventing proper engagement.

Some lift trucks provide a fork tilt indicator; however, these indicators measure fork tilt relative to the truck's mast, but not relative to support surface proximity. Further, monitoring fork tilt either by sensing the vertical component of the fork or at the heel of the fork will not take into consideration the deflection of the fork away from the mast due to the weight of the load.

Lift truck alignment systems in the past, only adjusted the height of the forks and did not have a vertical tilt system that allowed for the mast to move away from its vertical positioning. Also, earlier lift systems only checked for the verticality of the forklift mast and not the actual lift fork itself.

For example, U.S. Pat. No. 4,212,375 [Peterson, et. al.] discloses a dual acting contact arm located in the distal end of a lift fork for contacting surfaces both below and above the fork. The system responds to contact of the surface above or below by automatically adjusting the distance between the forks and the nearby surface. Although the system produces a semi-automatic response, outside of the operator's control, to avoid damaging the pallet or the material loaded on the pallet, there is still a need for feedback indicators for the operator to visually indicate that there is a problem and a need to address the problem.

There is also a need for detecting the movement of the mast away from its intended vertical alignment for lifting. One such system is described in U.S. Patent Application Publication No. US 2003/0234721 A1 [Figueira] as a vertical leveler system for a lift truck that provides a warning when the vertical mast of the lift truck is not perfectly vertical to the underlying surface. The system includes a level state detector, an alarm and indicator lights. The level state detector is described as a gravity-actuated pendulum, a conductive fluid bubble-type level indicator, or some other gravity dependent level state indicator. The system detects differences from true vertical positioning, corrections to the positioning of the mast, and provides indicators to show “forward” or “backward” tilt of the mast to the operator. Even with this detection and correction indicator system, there remains a need for a combined system which can be utilized to not only check the verticality of the forklift mast, but also the horizontalness of the lift fork and its distance from an obstruction to avoid damage to pallets and materials.

Previous lift trucks combined fork level sensors located in the forks with cameras mounted in a housing and moved vertically to allow viewing on a video display terminal by the operator to determine how to position the forks in respect to the load to be lifted. These patents show the state of the art currently in the field of Lift Truck Alignment. For example, U.S. Pat. No. 5,586,620 [Dammeyer, et. al.] discloses a system that uses one or two cameras mounted to the lift fork back plate or carriage to provide remote viewing by the operator of the actual positions of the lift forks. Also, U.S. Pat. RE 37,215 [Dammeyer, et. al.] discloses the same use of the indicator system as was disclosed previously in his earlier patent, including the use of fork level sensors located within the forks and a vision system to show the view observed by the camera to assist the operator.

Additionally, U.S. Pat. No. 7,219,769 [Yamanouchi, et. al.] discloses a camera system to automatically align the lift forks with one or more viewed patterns affixed to the storage/shelf system and/or the individual cargo pallets. Electronic image processing matches and differentiates between the various predetermined images, and then the system calculates distances and auto-initiates control of the vehicle, forks, etc. by aligning the forks vertically with the known spacings between the shelf and the pallet and horizontally based upon a centering alignment on the image. The camera is mounted below and to the rear of the lift forks and moves with the forks as they are controlled by the lift fork alignment system.

It is an object of the present invention to provide cooperating sensors that determine both alignment of the vertical mast and the lift forks, simultaneously, so that an operator can properly position his truck to lift a designated pallet of material. It is also an object of the present invention to provide a visual indication of the proper alignment/positioning of the vertical mast and the lift forks clearly and easily viewed by the operator.

It is yet another object of this invention to provide a system for simultaneously indicating an appropriate distance above the underlying surface for insertion of the forks under the pallet, and for the adjustment of the vertical mast to a position of perpendicularity to the underlying surface, which, in turn, allows the operator the ability to insert the forks under a waiting pallet without having to actually view the precise position of the forks in respect to the pallet.

It is another object of this invention to increase the speed that an operator moves the pallet, by eliminating the time that he would have spent trying to visually determine the position of the forks before inserting them into the waiting pallet. It is yet another object of this invention to eliminate the damage that occurs from “spearing” product that is loaded on pallets. When the operator sets his forks as indicated by the two sensor lights, the pallet will be properly approached and no material can be damaged.

These and other objects and advantages of the invention will be apparent to those skilled in the art in light of the following disclosure, claims and accompanying drawings.

### SUMMARY OF THE INVENTION

The present invention includes a lift truck fork alignment system with position detection sensors and indicator lamps visible to the operator. The apparatus includes a sensor system for detecting the perpendicularity of the vertical mast and the support surface proximity to the lift forks of a material handling vehicle with respective cooperating operator indicators to show improper and proper alignment.

The apparatus includes positioning sensors appropriately mounted to the lift truck, indicator lamps for operator indication of faults or appropriate alignment, which work together to eliminate damage that occurs from “spearing” product loaded on pallets. In order to determine the proper position of the forks, the operator positions the mast and the forks to a lifting position and refers to the indicator lights for a determination of mast verticality, perpendicularity to the underlying surface, and minimal distance of the forks from the underlying surface. The system determines the proper position of both vehicle lift elements from a proximity sensor and a level sensor, which are mounted onto the vehicle, as visually indicated by the state of two independent indicator lights, one for proximity and one for perpendicularity.

The system, through use of the respective sensors, determines that adjustment of the mast of the lift truck is necessary and the operator makes the adjustment. Once the adjustment has been made the mast verticality indicator illuminates the lamp indicating substantial perpendicularity of the mast to the underlying surface. The other sensor determines the need for adjustment to the height of the forks so that the forks are properly aligned with the pallet. The forks proximity indicator illuminates the lamp indicating sufficient clearance to the underlying surface and, by physical structure, clearance to the underside of the pallet, to alert the operator that the forks may be inserted into the pallet structure and the load may be lifted. These indicator lamps are mounted in the operator's line of sight on either side of the vertical mast.

The apparatus of the present invention for substantially simultaneously detecting the spatial relationships of the forks of a forklift vehicle to the underlying support surface for the vehicle is comprised of a first sensing means for detecting the perpendicularity of the mast of the forklift vehicle to the underlying support surface, a second sensing means for detecting the vertical height displacement of the forks of the lift vehicle from the underlying support surface, and first and second indicator means for respectively indicating the combined detected preconditions of the lift forks to the forklift operator for operating the forklift vehicle to lift a pallet without the need for the operator to visually check the position of the forks prior to inserting the forks under the pallet load support surface. The first sensing means includes a level detection sensor providing a verticality measurement that is electrically connected in series to one of the first and second indicator means. The second sensing means includes an inductive sensor mounted to the vertical portion of the mast juxtaposed opposite a metal tab protruding outward from and mounted to the vertical portion of the forks providing a vertical height displacement measurement that is also electrically connected in series to other one of the first and second indicator means. Each of the first and second indicator means are lamps illuminated in response to the detected measurements of the first and second sensing means, respectively, and positioned in the line-of-sight of the vehicle operator.

Overall, the invention may be described as a sensor system for detecting both vertical and horizontal alignment of forklift vehicle forks, which sensor system is comprised of a first position detecting sensor for measuring and determining the verticality or perpendicularity of the forklift vehicle mast in respect to the underlying support surface, a second position detecting sensor for measuring and determining the vertical height of the forks above the underlying support surface; and first and second operator lamp indicators to show proper alignment of the forks with a pallet for operating the forklift vehicle to lift a pallet without the operator visually checking the position of the forks prior to inserting the forks under the pallet load support surface. As before, the first positioning sensor includes a level sensor located on the mast of the forklift vehicle for measuring and determining the verticality or perpendicularity of the mast to the underlying support surface. The second positioning sensor includes a proximity sensor mounted to the vertical portion of the mast juxtaposed opposite a metal tab protruding outward from and mounted to the vertical portion of the forks for measuring and determining a vertical height displacement measurement of the forks above the underlying support surface. Finally, the sensor system includes first and second operator lamp indicators that receive respective signals from the first and second position detecting sensors causing the indicators to alert the operator of the detected preconditions of fork alignment so the operator can insert the forks under the pallet load support surface and lift the load without causing damage to either the pallet or the load.

The invention may also be described as a method of safely inserting the forks of a lift vehicle under a load of material situated on a pallet. This method, for substantially simultaneously detecting the spatial relationships of the forks of a forklift vehicle, comprises the steps of providing a first sensing means for detecting the perpendicularity of the mast of the forklift vehicle to the underlying support surface, providing a second sensing means for detecting the vertical height displacement of the forks of the lift vehicle from the underlying support surface, and providing first and second indicator means for respectively indicating the combined detected preconditions to the forklift operator for operating the forklift vehicle to lift a pallet without the operator visually checking the position of the forks prior to inserting the forks under the pallet load support surface. Included in the method step of providing the first sensing means are the further steps of providing a verticality measurement from a level detection sensor mounted to the mast of the forklift vehicle and providing a level detection signal to one of the first and second indicator means to alert the operator of an alignment condition satisfactory for operation of the forklift vehicle. Included in the method step of providing the second sensing means are the further steps of providing a vertical height displacement measurement from an inductive sensor mounted to the vertical portion of the mast juxtaposed opposite a metal tab protruding outward from and mounted to the vertical portion of the forks and providing a height displacement signal to one of the first and second indicator means to alert the operator of an alignment condition satisfactory for operation of the forklift vehicle. Included in the method step of providing first and second indicator means are the further steps of providing respective signals from the first and second position detecting sensors of the measured alignment of the forks of the forklift vehicle to first and second operator lamp indicators and causing the indicators to alert the operator of the detected preconditions of fork alignment so the operator can insert the forks under the pallet load support surface and lift the load without causing damage to either the pallet or the load.

### BRIEF DESCRIPTION OF THE DRAWINGS

FIG. 1 is a diagrammatic view of the lift truck fork aligning system and cooperating parts showing the circuitry for the dual sensor system from the point of view of the operator.

FIG. 2 is a side view of the lift truck mast and fork showing the location of the dual position determining sensors and operator indicator lamps for the lift truck fork aligning system.

### DETAILED DESCRIPTION OF THE INVENTION

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

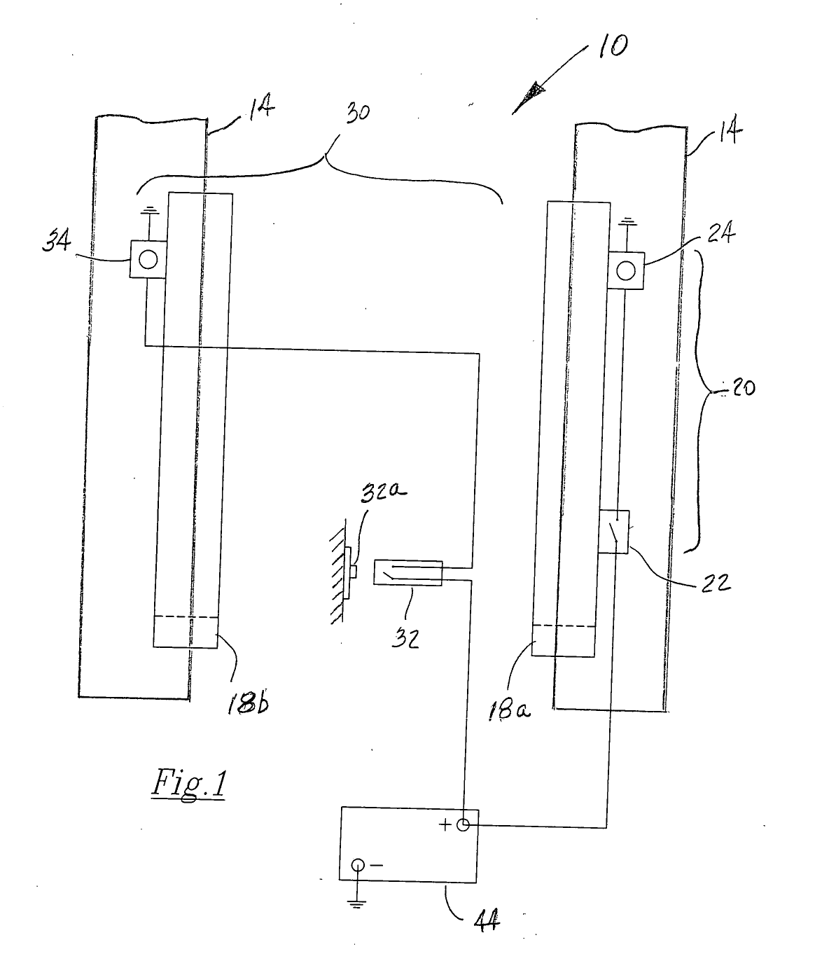

Referring now to the drawings in detail, where like numerals refer to like parts or elements, there is shown in FIG. 1 a lift truck fork aligning and positioning system 10. The system 10 consists of dual fork alignment and positioning sensors that provide a verticality determination for the forklift mast and a predetermined height determination for the forks, and include indicator lamps for visual operability checks for the operator. Thus, the aligning and positioning system 10 comprises a first sensing means 20 that includes a verticality sensor 22 and associated indicator lamp 24, and a second sensing means 30 that includes a predetermined fork height sensor 32 and associated indicator lamp 34.

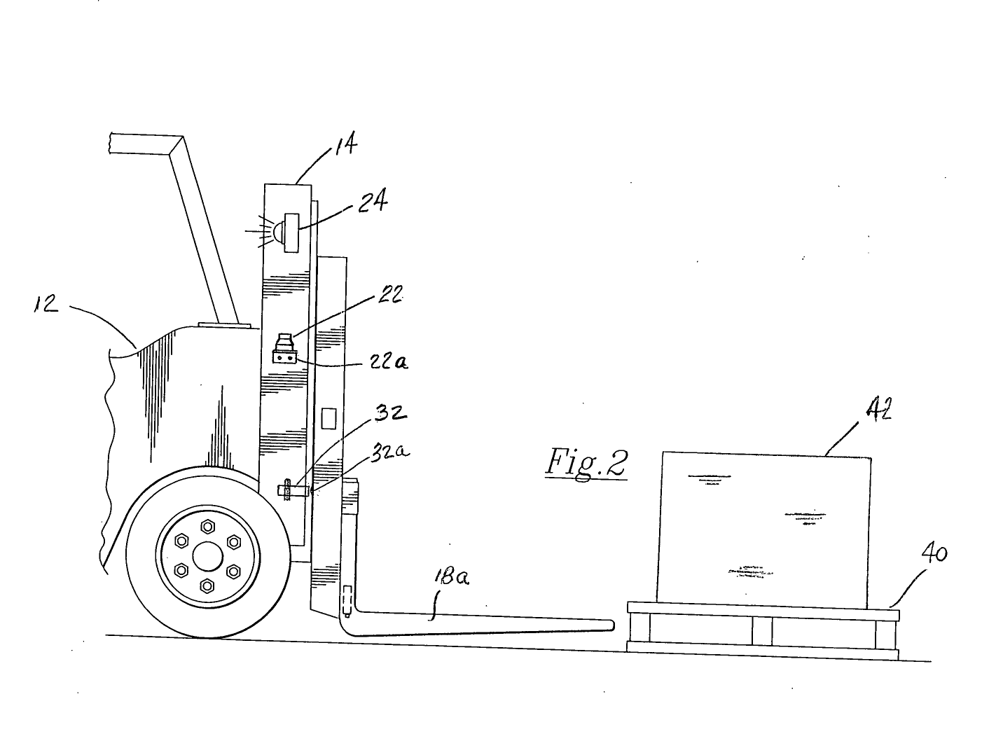

With reference to FIG. 2, the first sensing means 20 is located one of the side rails of the vertical mast 14 of the lift vehicle 12. The sensing means 20 includes the verticality sensor 22 and the lamp indicator 24. The verticality sensor 22 is adapted to mount to the vertical rail 16 of the mast 14 of the lift vehicle 12 by means of an angle-plate 22a supporting the sensor from below. The verticality sensor 22 can be of any kind or type that determines the perpendicularity of the mast 14 to the surface upon which the lift vehicle is riding or positioned. This can be accomplished, for example, by a bubble level sensor that is mounted to the mast 14 along one of its vertical rails 16 in such fashion that the perpendicularity to the underlying surface is established, and a circuit is completed to an indicator lamp 24, when the sensor determines a true level condition. In this example, the operating condition, perpendicularity of the mast 14, is established using a bubble level sensor that is preset to measure the forward and backward tilt of the mast 14. Other suitable sensors, creating substantially the same measurement, can also be utilized to complete the circuit upon achieving the condition of perpendicularity, i.e., true verticality of the mast 14. Upon achieving the appropriate sensed measurement, i.e., verticality, the circuit is completed and the lamp indicator 24 illuminated. The lamp indicator 24 is mounted on one of the side rails of the mast 14 in full view of the operator in order that the operator is able to visually determine that the mast is in a perpendicular (vertical) alignment to the surface underlying the vehicle 12.

When the mast 14 of the fork lift vehicle 12 is measured to be perpendicular to the surface under the vehicle 12, then the forks 18a, 18b, by arrangement of the operating unit of the lifting mechanism of the fork lifts and the mast of standard lift truck utility vehicles which are at right angles to each other, will be in parallel alignment to the underlying surface. All that is required is that the operator set the height of the forks 18a, 18b to avoid “spearing” either the pallet 40 or the load 42.

The second sensing means is comprised of a proximity sensor 32 that is desired to sense and determine the vertical displacement of the top surface of the forks above the underlying surface. The proximity sensor 32 is positioned along the outer surface of one of the vertical sections of the mast 14, which lifting and lowering mechanism housed in the mast 14 is directly connected to the forks 18a, 18b. When located on the vertical section of the mast 14, the proximity sensor 32 is mounted in a horizontal position with its sensor facing toward the lift vehicle forks 18a, 18b. Along the rearward facing section of one of the forks 18a or 18b, immediately juxtaposed to the proximity sensor 32, is a cooperating metal protrusion 32a that may be formed from a bolt, screw, lug nut, and the like, that protrudes slightly outward (rearward) of the rear surface of the selected one of the forks 18a or 18b creating a different dimensional relationship in the form of a shorter distance between the proximity sensor 32 and the surface of one of the forks 18a or 18b.

This protrusion, or tab, 32a can be adjusted vertically, and inward and outward, to achieve the appropriate height dimensional measurement and the best response from the proximity sensor 32. This permits the proximity sensor 32 to detect, not only the precise point when the forks are at the desired height above the underlying surface, but also a range of approximately Y2 inch above and below the juxtaposed position of the proximity sensor 32 and the tab 32a. When the tab 32a is detected within the range of the proximity sensor 32 described immediately above, a circuit is completed and the forks position indicator 34 located on one of the vertical sections of the mast 14 is illuminated. As above, the lamp indicator 34 is mounted so as to be in full view of the operator in order that the operator is able to visually determine that the forks 18a, 18b are at the predetermined (vertical) height from the surface underlying the vehicle 12.

The proximity sensor 32 is preferred to be an amplified inductive sensor that detects the immediate proximity of a magnetic element, such as the tab 32a, when within a preset distance. The preset distance of offset from direct juxtaposition can be adjusted, but in the preferred mode, the offset distance is no more than approximately ½ inch above and below the juxtaposed position of the sensor 32 and the tab 32a. In this fashion the upper surface of the forks 18a, 18b will be at approximately the desired distance of three (3) inches above the underlying surface, which falls within the range of dimensions for inserting the forks 18a, 18b into the openings in the pallet 40 without damaging the pallet structure or spearing the load 42. Of course, other sensor types may be as effective in determining the exact height of the forks above the underlying surface. Although other sensors may require a different mounting technique, they will also produce a similar response in detecting the height distance of the upper surface of the forks above the underlying surface.

Referring again to FIG. 2, a side view of the lift truck fork 18a (18b is directly behind and not shown) showing the lift vehicle 12 proximate to a pallet 40 carrying a load of material 42. The fork 18a is shown in parallelity with and a predetermined height above the underlying surface so as to be able to clear the upper and lower supports of the pallet 40, i.e. enter the pallet between these supporting members, and at the same time avoid skewering or spearing the load 42. For most pallets having a substantially standard dimensional construction, a height of three (3) inches above the underlying support surface is sufficient for a lift truck fork, e.g. forks 18a, 18b, to clear the pallet support members and be positioned directly under the load platform of the pallet 40. In order for the forks 18a, 18b to be in parallelity with the underlying support surface, the mast 14 must also be perpendicular to that surface due to the precise 90° relationship of the mast 14 to the top surface of the forks 18a, 18b.

A fork height indicator lamp 34 is located at approximately eye level of a seated operator of the forklift vehicle 12 and mounted to the outer or rear surface of the mast 14 to be easily visible by the operator. The fork height indicator lamp 34 provides the operator with visual feedback that the proximity sensor 32 has detected the tab 32a and the forks 18a, 18b are at the preferred height above the surface. The mast verticality indicator lamp 24 provides the operator with visual feedback that the mast 14 is perpendicular to the underlying surface which, in turn, results in the forks 18a, 18b being in parallelity with the surface, as well. Thus, with both indicators 24, 34 illuminated, the operator is assured that the forks 18a, 18b and the mast 14 are appropriately positioned for the operator to initiate the entry of the forks 18a, 18b into the pallet and the lifting and relocating of the pallet 40 and the load 42 contained thereon.

Each of the sensing means 20, 30 are connected to an electrical supply, e.g., the forklift vehicle battery 44, so that the measurement, detection and signaling functions can proceed on a continuous basis. The sensing means are appropriately isolated, electrically, from intermittent noise that may falsely trigger a signal when unwarranted and securely mounted to the respective structures of the lift vehicle 12 to provide continuous valid measurements to the operator.

Those skilled in the art may perceive improvements, changes and modifications in the invention, all of which are intended to be covered by and included within the scope of the claims set forth herein, and that all matter contained in the accompanying specification shall be interpreted as illustrative only and not in a limiting sense. The present invention may also be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention, as well as all modifications which may fall within a range of equivalency which are also intended to be embraced therein.

1. An apparatus for substantially simultaneously detecting the spatial relationships of the forks of a forklift vehicle comprising:
a first sensing means for detecting the perpendicularity of the mast of the forklift vehicle to the underlying support surface;
a second sensing means for detecting the vertical height displacement of the forks of the lift vehicle from the underlying support surface; and,
first and second indicator means for respectively indicating the combined detected preconditions to the forklift operator for operating the forklift vehicle to lift a pallet without the operator visually checking the position of the forks prior to inserting the forks under the pallet load support surface.

2. The apparatus of claim 1, wherein the first sensing means includes a level detection sensor providing a verticality measurement and connected in series to one of the first and second indicator means.

3. The apparatus of claim 1, wherein the second sensing means includes an inductive sensor mounted to the vertical portion of the mast juxtaposed opposite a metal tab protruding outward from and mounted to the vertical portion of the forks providing a vertical height displacement measurement and connected in series to one of the first and second indicator means.

4. The apparatus of claim 1, wherein the first and second indicator means are lamps illuminated in response to the detected measurements of the first and second sensing means, respectively.

5. A sensor system for detecting both vertical and horizontal alignment of forklift vehicle forks comprising:
a first position detecting sensor for measuring and determining the verticality or perpendicularity of the forklift vehicle mast in respect to the underlying support surface;
a second position detecting sensor for measuring and determining the vertical height of the forks above the underlying support surface; and,
first and second operator lamp indicators to show proper alignment of the forks with a pallet for operating the forklift vehicle to lift a pallet without the operator visually checking the position of the forks prior to inserting the forks under the pallet load support surface.

6. The sensor system of claim 5, wherein the first positioning sensor includes a level sensor located on the mast of the forklift vehicle for measuring and determining the verticality or perpendicularity of the mast to the underlying support surface.

7. The sensor system of claim 5, wherein the second positioning sensor includes a proximity sensor mounted to the vertical portion of the mast juxtaposed opposite a metal tab protruding outward from and mounted to the vertical portion of the forks for measuring and determining a vertical height displacement measurement of the forks above the underlying support surface.

8. The sensor system of claim 5, wherein the first and second operator lamp indicators receive respective signals from the first and second position detecting sensors causing the indicators to alert the operator of the detected preconditions of fork alignment so the operator can insert the forks under the pallet load support surface and lift the load without causing damage to either the pallet or the load.

9. A method for substantially simultaneously detecting the spatial relationships of the forks of a forklift vehicle comprising the steps of:
providing a first sensing means for detecting the perpendicularity of the mast of the forklift vehicle to the underlying support surface;
providing a second sensing means for detecting the vertical height displacement of the forks of the lift vehicle from the underlying support surface;
providing first and second indicator means for respectively indicating the combined detected preconditions to the forklift operator for operating the forklift vehicle to lift a pallet without the operator visually checking the position of the forks prior to inserting the forks under the pallet load support surface.

10. The method of claim 9, wherein the step of providing the first sensing means further comprises the steps of:
providing a verticality measurement from a level detection sensor mounted to the mast of the forklift vehicle, and
providing a level detection signal to one of the first and second indicator means to alert the operator of an alignment condition satisfactory for operation of the forklift vehicle.

11. The method of claim 9, wherein the step of providing the second sensing means further comprises the steps of:
providing a vertical height displacement measurement from an inductive sensor mounted to the vertical portion of the mast juxtaposed opposite a metal tab protruding outward from and mounted to the vertical portion of the forks, and
providing a height displacement signal to one of the first and second indicator means to alert the operator of an alignment condition satisfactory for operation of the forklift vehicle.

12. The method of claim 9, wherein the step of providing first and second indicator means further comprises the steps of:
providing respective signals from the first and second position detecting sensors of the measured alignment of the forks of the forklift vehicle to first and second operator lamp indicators;
causing the indicators to alert the operator of the detected preconditions of fork alignment so the operator can insert the forks under the pallet load support surface and lift the load without causing damage to either the pallet or the load.
